(19) United States
(12) Patent Application Publication
(10) Pub. No.: US 2025/0234875 A1
(43) Pub. Date: Jul. 24, 2025

(54) NEW FERMENTED MILK PRODUCT AND PROCESS FOR PRODUCTION THEREOF

(71) Applicants: DSM IP ASSETS B.V., Heerlen (NL); Technische Universiteit Eindhoven, Eindhoven (NL)

(72) Inventors: Mariska BRUELS, Eindhoven (NL); Sanam FOROUTANPARSA, Eindhoven (NL); Roderick Prudent TAS, Eindhoven (NL); Ilja Karina VOETS, Eindhoven (NL); Joost Christiaan VAN'T HOFF, Echt (NL); Cornelia Elizabeth Paulina MALJAARS, Echt (NL)

(21) Appl. No.: 18/699,804

(22) PCT Filed: Oct. 11, 2022
(86) PCT No.: PCT/EP2022/078196

§ 371 Date: Apr. 9, 2024

(30) Foreign Application Priority Data
Oct. 11, 2021 (EP) 21201981.4
Oct. 12, 2021 (EP) 21202251.1
Oct. 28, 2021 (EP) 21205280.7
Mar. 31, 2022 (EP) 22166106.9
Jun. 21, 2022 (EP) 22180175.6

(51) Int. Cl. A23C 9/123

(52) U.S. Cl. CPC A23C 9/1236; A23C 9/1238; A23C 2220/206

(57) ABSTRACT

A fermented milk product, wherein the fermented milk product comprises:
a porous protein network;
a first, capsular, preferably negatively charged, exopolysaccharide; and
a second, non-capsular, preferably neutral, exopolysaccharide.

A starter culture comprising a first, preferably negatively charged, capsular, exopolysaccharide producing lactic acid bacterial strain and a second, preferably neutral, non-capsular, exopolysaccharide producing lactic acid bacterial strain, wherein the weight ratio of the weight of the first exopolysaccharide producing lactic acid bacterial strain to the weight of the second exopolysaccharide producing lactic acid bacterial stain in the starter culture lies in the range from equal to or more than 1:1 to equal to or less than 100:1, more preferably in the range from equal to or more than 10:1 to equal to or less than 100:1; and a use thereof and process using such.

### FIELD OF THE INVENTION

The invention relates to a novel fermented milk product. In addition, the invention provides a novel process for preparing such a novel fermented milk product and a novel bacterial starter culture for use therein.

### BACKGROUND OF THE INVENTION

During the preparation of fermented milk products, milk is acidified by bacterial cultures. These bacterial cultures ferment a sugar such as lactose, into an acid, such as lactic acid. Bacterial cultures that ferment lactose to produce lactic acid as their main product are sometimes also referred to as lactic acid bacteria (LAB). The lactic acid assists in giving a fermented milk product its typical aroma.

In the preparation of fermented milk products it is further desirable that acidification also causes the formation of an acid-induced gel within the milk, also simply referred to as an “acid gel”. The formation and rheological properties of acid gels in milk have been studied, but little is known about the factors and mechanisms influencing the underlying microstructures involved. For example, how differences in monosaccharide composition and physico-chemical properties of polysaccharides influence yoghurt network formation and texture is not yet fully understood.

In the article by Lucey et al., titled “Formation and physical properties of acid milk gels: A review”, published in Food Research International Vol. 30, pages 529-542 (1997), it is suggested that the acid gel network in yoghurt is formed from micelle-like particles. It is further mentioned that during acidification of milk, many of the physicochemical properties of casein micelles undergo considerable change. The gels are believed to consist of a coarse particulate network of casein particles linked together in clusters, chains and strands. This network is said to have pores (also referred to as void spaces) where the aqueous phase is confined. The diameter of these pores may vary from 1-30 micrometer, with larger pores in gels made at high gelation temperatures and from milks with a low protein content.

In recent years an increased demand has developed for fermented milk products with a non-ropy (also referred to as “short”) rather than a ropy (also referred to as “long”) structure and/or a firmer acid gel. The ropiness of a fermented milk product can be decreased by using certain additives, but products produced in this manner are often perceived by consumers as more artificial and therefore less desirable.

In the article by Lynch et al., titled “Lactic Acid Bacteria Exopolysaccharides in Foods and Beverages: Isolation, Properties, Characterization, and Health Benefits” published in the Annual Review of Food Science and Technology (2018) it is described that in fermented milk, such as yoghurt, EPSs can affect the formation of the casein-gel structure by acting as a filler and as nuclei for the formation of serum channels and large pores containing bacterial cells, EPSs, and milk serum.

U.S. Pat. No. 7,323,199B explains that both set yoghurt and stirred yoghurt undergo the phenomenon of water separation, called “syneresis”. Syneresis is said to take place during fermentation. One of the measures mentioned as frequently used for product stability and improved thickening is the addition of stabilizers or texturizers (chemically modified starch, carrageenan, guar gum, pectin, gelatin, etc.), but those food additives may adversely affect the true taste and aroma of yoghurt. In addition, the use of those hydrocolloids is said to result in a non-natural image, and it is not allowed in all countries. The use of yoghurt starter cultures that contain strains that produce exopolysaccharides (S. thermophilus, Lb. delbrueckii subsp. bulgaricus or both) is said to be a promising alternative. However, U.S. Pat. No. 7,323,199B finds that exopolysaccharide production in milk by thermophilic lactic acid bacteria such as Streptococcus thermophilus is low and unstable when carried out using the traditional batch process technologies for the production of yoghurt.

U.S. Pat. No. 7,323,199B aimed to provide a yoghurt or other fermented milk product which had an acceptable viscosity and texture, which could retain water and did not show excessive syneresis. As a solution it proposes a method for obtaining fermented milk products, comprising inoculating a starter medium with a starter culture comprising an exopolysaccharide producing microorganism, followed by a two-step fermentation process, comprising: 1) an exopolysaccharide production step wherein the pH of said starter medium is kept stable at a predetermined pH value at a suitable temperature; and 2) an acidification step to allow clotting of the starter medium. That is, exopolysaccharide production and acidification are carried out in separate steps. The proposed process is cumbersome from an industrial perspective as the two-step fermentation adds more room for product variation and adds more stages where quality control is needed. In the example of U.S. Pat. No. 7,323,199B a two-step process was illustrated where in a first step the exopolysaccharides were grown whilst the PH was kept constant at pH 6.2 through online control by automatic addition of 10 N NaOH. When approximately 50.0% of the lactose present in the fermentation medium was consumed, the pH control was switched off and the second step of the process (the acidification step) was started. The fermentation was stopped after 24 h when a final pH of 4.6 was reached. As illustrated by this example, the two-step process of U.S. Pat. No. 7,323,199B needs considerable amounts of a basic additive to control the pH in the step. The presence of such additives is again undesirable from a consumer perspective.

Duboc et al., in their article titled “Applications of exopolysaccharides in the dairy industry”, published in the International Dairy Journal, vol. 11, pages 759-768 (2001) describe that certain strains of lactic acid bacteria (LAB) are able to synthesize exopolysaccharides (EPS). They indicate that there is large variability in EPS production by LAB in terms of quantity, chemical composition, molecular size, charge, presence of side chains, and rigidity of the molecules. It is stated that EPS's may act both as texturizers and stabilizers in a fermented dairy product, firstly increasing the viscosity of a final product, and secondly by binding hydration water and interacting with other milk constituents, such as proteins and micelles, to strengthen the rigidity of the casein network. Duboc et al. mention that the microstructure of yoghurt consists of a matrix of aggregated casein particles and indicates that fat globules are embedded in this matrix. The cavities of the gels are filled with serum and bacterial cells. An envelope of EPS is observed surrounding the bacterial starter strains, by which ropy cells attach to the protein matrix via a web of filaments. However, Duboc et al. indicate that there is a problem in that the production of one kind of EPS may not satisfy all texture specifications.

Hassan et al, in their article titled “ADSA foundation scholar award: Possibilities and challenges of exopolysaccharide-producing lactic cultures in dairy foods”, published in the Journal of Dairy Science. Vol. 91, pages 1282-1298 (2008) describe that Exopolysaccharides (EPS) from lactic acid bacteria are a diverse group of polysaccharides. Hassan et al explain that two forms of EPS are produced by lactic acid bacteria: capsular and unattached. Hassan et al further state that segregation of EPS and protein in yoghurt produces a more densely aggregated protein network than that in the EPS-negative yoghurt. According to Hassan et al, exopolysaccharides decrease interactions between protein aggregates, leading to lower viscoelastic moduli, yield stress, and firmness. In addition they indicate that reduction in the rigidity of the protein network caused by EPS is expected to induce syneresis. According to the article it seems that the open structure of yoghurt produced by the EPS-positive strains increases syneresis, while the ability of EPS to bind or trap milk serum is responsible for the high water-holding capacity of the final fermented product. Hassan et al conclude that the effect of EPS on protein matrix and structure formation depends on their concentration, interactions with the protein, and molecular and rheological characteristics and indicate that studying the relationship between EPS and casein micelles is rather complex.

As illustrated by the above prior art, the factors and mechanisms influencing the underlying microstructures involved in a fermented milk product remain poorly understood. In addition, there is a continued desire for a fermented milk product that can be produced without artificial additives, has desirable mild lactic acid aroma and has a non-ropy structure (i.e. a “short” structure) and/or a firm and/or dense acid gel, but that can retain water and/or does not show excessive syneresis

It would therefore be an advancement in the art to provide such a fermented milk product that can be produced without artificial additives, has a desirable mild lactic acid aroma and has a non-ropy structure (i.e. a “short” structure) and/or a firm and/or dense acid gel, but that can retain water and/or does not show excessive syneresis.

### SUMMARY OF THE INVENTION

Inventors have now surprisingly found such a fermented milk product and a process for the production thereof.

Accordingly, in a first aspect, the invention provides a fermented milk product, wherein the fermented milk product comprises:
a porous protein network;
a first, capsular, preferably negatively charged, exopolysaccharide; and
a second, non-capsular, preferably neutral, exopolysaccharide.
   The first, capsular, preferably negatively charged, exopolysaccharide is preferably attached to or integrated within the porous protein network, whilst the second, non-capsular, preferably neutral exopolysaccharide is preferably located within the pores of the porous protein network. Preferably the exopolysaccharides are heteropolysaccharides.

In a second aspect, the invention provides a starter culture or kit of parts comprising a capsular, preferably negatively charged, exopolysaccharide producing lactic acid bacterial strain and a non-capsular, preferably neutral, exopolysaccharide producing lactic acid bacterial strain, wherein the weight ratio of the weight of capsular exopolysaccharide producing lactic acid bacterial strain to the weight of the non-capsular exopolysaccharide producing lactic acid bacterial stain in the starter culture lies in the range from equal to or more than 1:1 to equal to or less than 100:1, more preferably in the range from equal to or more than 10:1 to equal to or less than 100:1.

In a third aspect, the invention provides for the use of such a starter culture or kit of parts for the production of a fermented milk product, for example for the purpose to improve syneresis, gel firmness (i.e. gel stiffness) and/or rheology.

Further, in a fourth aspect, the invention provides a process for the production of a fermented milk product comprising the fermentation of a milk base in the presence of a capsular, preferably negatively charged, exopolysaccharide producing lactic acid bacterial strain and a non-capsular, preferably neutral, exopolysaccharide producing lactic acid bacterial strain, wherein the weight ratio of the weight of capsular exopolysaccharide producing lactic acid bacterial strain to the weight of the non-capsular exopolysaccharide producing lactic acid bacterial stain lies in the range from equal to or more than 1:1 to equal to or less than 100:1, more preferably in the range from equal to or more than 10:1 to equal to or less than 100:1.

Inventors found that the above allows for the production of a fermented milk product that comprises a unique structure, resulting in a non-ropy structure (i.e. a “short” structure) and/or a, firm and/or dense, acid gel. Although not excluded, the additives as described in the prior art, such as the NaOH, are no longer necessary to obtain the desired acid-induced gel. As further illustrated by the examples the obtained fermented milk product may further comprise a desirable mild lactic acid aroma and can retain water and/or does not show excessive syneresis.

### BRIEF DESCRIPTION OF THE DRAWINGS

The invention is illustrated by the following figures:

FIG. 1 shows the Stimulated Emission Depletion (STED) microscopy images of protein regions in the fermented milk products as obtained for: i) a control with GDL induced MPC80 gel; ii) comparative example B, i.e milk fermented with only Strain B; iii) comparative example A, milk fermented with only Strain A; and iv) example 1 according to the invention, i.e. milk fermented with a combination of Strain A and Strain B. The images on the top row show the β-casein network, whilst the images on the bottom row show the αS1-casein network.

FIG. 2 shows the differences in syneresis in the fermented milk products. V2 illustrates the result for comparative example B, i.e. a milk fermented with only Strain B; V3 illustrates the result of comparative example A i.e. a milk fermented with only Strain A; and V4 illustrates the result of example 1 according to the invention, i.e. milk fermented with a combination of Strain A and Strain B.

### DETAILED DESCRIPTION OF THE INVENTION

### Definitions

Unless defined otherwise or clearly indicated by context, all technical and scientific terms used herein have the same meaning as commonly understood by one of ordinary skill in the art.

Throughout the present specification and the accompanying claims, the words “comprise” and “include” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element. When referring to a noun (e.g. a compound, an additive, etc.) in the singular, the plural is meant to be included. Thus, when referring to a specific moiety, e.g. a “strain”, this means “at least one” of that strain, e.g. “at least one strain”, unless specified otherwise.

When referring to a compound of which several isomers exist (e.g. a D and an L enantiomer), the compound in principle includes all enantiomers, diastereomers and cis/trans isomers of that compound that may be used in the particular aspect of the invention; in particular when referring to such as compound, it includes the natural isomer(s).

Unless explicitly indicated otherwise, the various embodiments of the invention described herein can be cross-combined.

The term “milk” is intended to encompass milks from mammals and plant sources or mixtures thereof. Preferably, the milk is from a mammal source. Mammals sources of milk include, but are not limited to cow, sheep, goat, buffalo, camel, llama, horse or reindeer. In an embodiment, the milk is from a mammal selected from the group consisting of cow, sheep, goat, buffalo, camel, llama, horse and deer, and combinations thereof. Plant sources of milk include, but are not limited to, milk extracted from soy bean, pea, peanut, barley, rice, oat, quinoa, almond, cashew, coconut, hazelnut, hemp, sesame seed and sunflower seed. Bovine milk is preferred. In addition, the term “milk” refers to not only whole milk, but also skim milk or any liquid component derived thereof or reconstituted milk.

The term “milk base” refers to a base composition, comprising milk or milk ingredients, or derived from milk or milk ingredients. The milk base can be used as a raw material for the fermentation to produce a fermented milk product. The milk base may for example comprise or consist of skimmed or non-skimmed milk, or reconstituted milk. Optionally the milk base may be concentrated or in the form of powder, or may be reconstituted from such. By reconstituted milk is herein understood liquid milk obtained by adding liquid, such as water, to a skim milk powder, skim milk concentrate, whole milk powder or whole milk concentrate. Furthermore, the milk base may or may not have been subjected to a thermal processing operation which is at least as efficient as pasteurization. Preferably the milk base is from a bovine source.

As used in this specification, the terms “fermented milk product”, “fermented dairy product” and “acidified milk product” are used interchangeably and are intended to refer to products which are obtained by the multiplication of lactic acid bacteria in a milk base leading to a milk coagulum. The particular characteristics of the various fermented milk products depend upon various factors, such as the composition of milk base, the incubation temperature, the composition of the lactic acid bacteria and/or presence of further non-lactic acid microorganisms. Thus, fermented milk products manufactured herein include, for instance, various types of yoghurt (including for example set yoghurt, low fat yoghurt, non-fat yoghurt), kefir, dahi, ymer, buttermilk, butterfat, sour cream and sour whipped cream as well as fresh cheeses such as quark and cottage cheese. Petit Suisse or Mozarella is yet another example of a fermented dairy product. Preferably the fermented milk product is a yoghurt.

As indicated by U.S. Pat. No. 7,323,199B, two basic types of yoghurt exist, according to its physical state in the retail container: set yoghurt and stirred yoghurt. Set yoghurt is fermented after being packed in a retail container, and stirred yoghurt is almost fully fermented in a fermentation tank before it is packed, the yoghurt gel being broken up during the stirring. The fermented milk product produced in the current invention can be a stirred yoghurt or a set yoghurt. Preferably the fermented milk product is a set yoghurt.

The terms “yoghurt” and “yogurt” are used interchangeably herein. The term “yoghurt” refers to products comprising or obtained by means of lactic acid bacteria that include at least Streptococcus salivarius thermophilus and Lactobacillus delbruekii subsp. bulgaricus, but may also, optionally, include further microorganisms such as Lactobacillus delbruekii subsp. lactis, Bifidobacterium animalis subsp. lactis, Lactococcus lactis, Lactobacillus acidophilus and Lactobacillus casei, or any microorganism derived therefrom. Such lactic acid strains other than Streptococcus salivarius thermophilus and Lactobacillus delbruekii subsp. bulgaricus, can give the finished product various properties, such as the property of promoting the equilibrium of the gut microbiota. As used herein, the term “yoghurt” encompasses set yoghurt, stirred yoghurt, drinking yoghurt, heat treated yoghurt and yoghurt-like products. More preferably, the term “yoghurt” encompasses, but is not limited to, yoghurt as defined according to French and European regulations, e.g. coagulated dairy products obtained by lactic acid fermentation by means of specific thermophilic lactic acid bacteria only (i.e. Lactobacillus delbruekii subsp. bulgaricus and Streptococcus salivarius thermophilus) which are cultured simultaneously and are found to be live in the final product in an amount of at least 10 million CFU (colony-forming unit)/g. Preferably, the yoghurt is not heat-treated after fermentation. Yoghurts may optionally contain added dairy raw materials (e.g. cream) or other ingredients such as sugar or sweetening agents, one or more flavouring(s), fruit, cereals, or nutritional substances, especially vitamins, minerals and fibers. Such yoghurt advantageously meets the specifications for fermented milks and yoghurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70% (m/m) of the finished product.

In the present context, the terms “fresh cheese”, “unripened cheese”, “curd cheese” and “curd-style cheese” are used interchangeably herein to refer to any kind of cheese such as natural cheese, cheese analogues and processed cheese in which the protein/casein ratio does not exceed that of milk.

The term “starter” or “starter culture” as used herein refers to a culture of one or more food-grade micro-organisms, more preferably a culture comprising lactic acid bacteria, which are responsible for the acidification of the milk base. Starter cultures may be fresh (liquid), frozen or freeze-dried. Freeze dried cultures need to be regenerated before use. For the production of a yoghurt, the starter culture (i.e. the total weight of all lactic acid bacterial combined) can for example be added in an amount from 0.001 to 10% by weight, suitably in an amount of 0.01 to 3% by weight, of the total amount of milk base. For the production of cheese, dosages in the lower part of the range can be used such as from 0.006% by weight of the total amount of milk base.

As used herein, the term “lactic acid bacteria”, “LAB”, “lactic acid bacterial strains” and “lactic bacteria” are used interchangeably and refer to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of lactose by these bacteria causes the formation of lactic acid, reducing the pH and leading to the formation of a protein coagulum. These bacteria are thus responsible for the acidification of milk and for the texture of the dairy product. As used herein, the term “lactic acid bacteria” or “lactic bacteria” encompasses, but is not limited to, bacteria belonging to the genus of Lactobacillus spp., Bifidobacterium spp., Streptococcus spp., Lactococcus spp., such as Lactobacillus delbruekii subsp. bulgaricus, Streptococcus salivarius thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve.

A strain is a genetic variant or subtype of a microorganism, in this case a subtype or variant of a lactic acid bacteria.

In line with common general knowledge a polysaccharide is herein understood to be a polymer of saccharides. The skilled person is further commonly aware that an exopolysaccharide (EPS) is a polysaccharide that is excreted by a cell into the surrounding medium (i.e. is not kept inside the cell). Two types of exopolysaccharide exist. A non-capsular exopolysaccharide (also sometimes simply referred to as an “exopolysaccharide”) is no longer attached to the cell wall. A capsular exopolysaccharide (also sometimes simply referred to as a “capsular polysaccharide”) is an exopolysaccharide that is situated externally to the cell but is still associated with or attached to the (outside surface) of the cell wall.

In line with common general knowledge a homopolysaccharide is herein understood to be a polymer made up out of one and the same monomer, i.e. comprises only one type of monosaccharide, whilst a heteropolysaccharide is understood to be a polymer made up out of two or more different monomers, i.e. comprises two or more different types of monosaccharide.

The below includes referrals to neutral and negatively charged exopolysaccharides. The negatively charged exopolysaccharides may herein also be described as anionic exopolysaccharides.

By the term “repeating unit” is herein preferably understood that part of the exopolysaccharide whose repetition would produce the complete exopolysaccharide chain (except for the end-groups) by linking the repeat units together successively along the chain. It is preferably understood as the elementary unit which periodically repeats itself in the exopolysaccharide chain.

### Fermented Milk Product

The invention provides a fermented milk product, wherein the fermented milk product comprises: a porous protein network; a first, capsular, preferably negatively charged, exopolysaccharide; and a second, non-capsular, preferably neutral, exopolysaccharide.

Without wishing to be bound by any kind of theory it is believed that due to the above structure, preferably having the characteristics as described below, the fermented milk product may have improved physical and sensory properties. Examples of such improved physical and sensory properties can be an improved connectivity and/or texture and/or an improved (lack of) syneresis. It is further believed that advantageously the aspects of this invention may allow for a natural enhancement of the texture of the fermented milk product (such as a yoghurt) without using any artificial additives. The combination of the porous protein network and the exopolysaccharides may suitably increase the compactness of the casein network and can increase the water holding capacity of the fermented milk product.

Such a porous protein network suitably comprises or consists of protein having a porous structure, i.e. a protein structure comprising pores. Such a porous protein network can be visualized as a protein skeleton, i.e. a kind of skeleton, for example having or in the form of a spatial distribution, made up of proteins. Such protein skeleton can hold other components together. The pores in the porous protein network can suitably have individual pore areas in the range from 1 to 1000 square micrometer. A structure comprising pores having individual pore areas in the range from 1 to 1000 square micrometer can herein also be referred to as microstructure. The porous protein network in the fermented milk product according to the invention can therefore also be referred to as a porous protein microstructure. The wording “porous protein network” and “porous protein structure” and “protein skeleton” and “porous protein microstructure” are used herein interchangeably.

Caseins constitute a large part of the protein in milk and preferably the above protein is a casein. The porous protein network thus preferably comprises or consists of a porous casein network, also referred to herein as a “porous casein structure”. Similar to the above, the wording “porous casein network” and “porous casein structure” and “casein skeleton” and “porous casein microstructure” are used herein interchangeably.

During the formation of yoghurt, lactic acid bacteria (LAB) can convert lactose present in milk into lactic acid. As a result, the pH of the milk can decrease. This in turn may cause the casein micelles in milk to destabilize. Casein micelles can be assemblies of four types of casein proteins (αₛ₁-, αₛ₂-, β-, and κ-caseins), and optionally colloidal calcium phosphate, held together for example by hydrophobic interactions and/or hydrogen bonding. In the pH range of 5.5 to 5, rearrangements of the casein micelles can occur. A further pH decrease to 4.6, the isoelectric point of caseins, can result in aggregation and gelation. In the different aspects of the invention a microstructure or network may then form that consists of an aggregated casein protein network with embedded fat globules and voids filled with serum with soluble proteins, lactose, bacterial cells and excreted metabolites. In the aspects of the invention the network and/or voids may suitably comprise a first, capsular, preferably negatively charged, exopolysaccharide; and a second, non-capsular, preferably neutral, exopolysaccharide.

There thus exist four main types of casein: αS1, αS2, β and κ-caseins. These caseins may be present in the milk in the form of casein aggregates called casein micelles. Inventors surprisingly found that the fermented milk product produced by the above process can comprise a protein network wherein casein proteins, optionally with the assistance of the capsular, preferably negatively charged, exopolysaccharide, are interconnected around voids (i.e. pores) comprising the major part or all of the second, preferably neutral, preferably non-capsular, exopolysaccharide. That is, the first, capsular, preferably negatively charged, exopolysaccharide is preferably attached to or integrated within the porous protein network, whilst the second, non-capsular, preferably neutral exopolysaccharide is preferably located within the pores of the porous protein network. The first, capsular, preferably negatively charged, exopolysaccharide can be attached to or integrated within the porous protein network in various ways. Preferably the first, capsular exopolysaccharide is negatively charged and attached to or integrated within the porous protein network by connecting to positively charged molecules, preferably positively charged proteins, within the porous protein network.

The porous casein network can comprise or consist of a αS1, αS2, β or κ-casein network. The porous casein network can also comprise or consist of a combination of different types of caseins. Most preferably the porous casein network comprises or consists of a β-casein network (i.e. a beta-casein network). However, good results can also be obtained where the porous casein network comprises or consists of a αS1-casein or a αS2-casein network, i.e. an alpha-casein network, or a κ-casein network, i.e. a kappa-casein network or combinations thereof. A porous casein network that comprises or consists of beta-casein and at least one alpha-casein, preferably αS1-casein, is especially preferred.

In one suitable embodiment the fermented milk product may comprise interconnected beta (β) caseins (which can also be referred to as an interconnected beta-casein network), whilst other caseins in the fermented milk product, such as for example αS1-caseins and/or αS2-caseins (i.e. one or more alpha-caseins), merely form loosely connected accumulations that are not interconnected. That is, in one embodiment the fermented milk product comprises:
an interconnected beta-casein network;
one or more alpha-casein accumulations;
a first, capsular, preferably negatively charged, exopolysaccharide; and
a second, non-capsular, preferably neutral, exopolysaccharide.

However, preferably the fermented milk product comprises interconnected beta (β) caseins as well as one or more interconnected alpha (α) caseins, preferably αS1-caseins, preferably intertwined together in the same network. Thus, preferably the fermented milk product comprises a porous protein network which porous protein network comprises interconnected alpha-casein and/or interconnected beta-casein, where the alpha-casein and beta-casein may or may not be interconnected to each other. That is, the fermented milk product preferably comprises:
a first, capsular, preferably negatively charged, exopolysaccharide; and
a second, non-capsular, preferably neutral, exopolysaccharide; and
an interconnected casein network comprising or consisting of beta (β) caseins and alpha (α) caseins, preferably αS1-caseins.
   Preferences described herein above and hereinbelow also apply to this specific embodiment. Without wishing to be bound by any kind of theory, the fermented milk product comprising both interconnected beta-casein as well as interconnected alpha-casein, preferably αS1-casein, is believed to give a higher level of connectivity, allowing a stiffer gel to be formed, i.e. a gel that has improved gel firmness. Such a structure is therefore advantageous when a non-ropy (short) structure is desired.

Preferably the porous protein network is an interconnected protein network, respectively an interconnected casein network, respectively an interconnected beta-casein and/or alpha-casein network. By an interconnected protein network, respectively an interconnected casein network, respectively an interconnected beta-casein network, is herein preferably understood a network of protein strands, respectively casein strands, respectively beta-casein or alpha-casein strands, that are fused or otherwise associated or connected to each other, thereby forming, preferably isolated, cavities, also referred to as pores or voids. Preferably, within the fermented milk product, the protein network, preferably comprising or consisting of casein proteins, optionally together with a first, capsular, preferably negatively charged, exopolysaccharide, preferably form(s) a continuous phase within which cavities (i.e. pores) are present, which cavities preferably comprise a second, non-capsular, preferably neutral, exopolysaccharide.

As for example described in the article by Ozcan et al, titled “Effect of increasing the colloidal calcium phosphate of milk on the texture and microstructure of yogurt”, published in the Journal of Dairy Science (2011), vol. 94, pages 5278-5288, incorporated herein by reference, it is commonly believed that during fermentation (for example to produce yoghurt) aggregation and gelation of casein (CN) may occur due to the reduction in charge repulsion with the decrease in milk pH. Within the casein micelles, casein molecules may be held together by hydrophobic interactions and/or (insoluble or casein-bound) colloidal calcium phosphate (CCP) crosslinks. These CCP crosslinks can be dissolved with a decrease in milk pH and caseins can be liberated into the serum phase.

Without wishing to be bound by any kind of theory, it is thus believed that the casein micelles in milk may contain one or more of the four different types of casein (for example αs1-, αs2-, β-, and κ-casein as mentioned above) together with calcium phosphate. Acid-induced destabilization of such casein micelles may aid in the formation of a fermented milk product such as yoghurt. Due to the applicable circumstances in the invention, the protein network may not simply form by aggregation of spherical casein micelles, but a change in protein organization can take place to form a porous protein structure. Without wishing to be bound by any kind of theory, it is believed that while β- and κ-caseins can be released from the micelles when the pH is lowered, αs1-casein can be retained in the micellar structure. Depending on the circumstances, at pH values below for example 4.9, the liberated caseins, such as for example the β- and/or κ-caseins, can form a network, optionally together with particulate αs1-caseins. This can advantageously result in a network of clusters and strands.

Preferably the porous protein network, respectively the porous casein network, therefore comprises protein, respectively casein, for example in the form of strands, that is/are fused or otherwise associated or connected, for example with help of or via:
capsular, preferably negatively charged, exopolysaccharide(s); and/or
hydrophobic interactions; and/or
optionally, colloidal calcium phosphate crosslinks.

As indicated above, the above preferably allows one to form a porous protein structure (i.e. comprising protein), respectively a porous casein structure (i.e. comprising casein), within which pores are present, which pores preferably comprise the non-capsular, preferably neutral, exopolysaccharide(s). The pores can be formed in the presence or absence of calcium phosphate crosslinks. Preferably the porous protein structure, respectively the porous casein structure comprises protein (i.e. protein molecules), respectively casein (i.e. casein molecules), that is/are connected to each other via capsular, preferably negatively charged, exopolysaccharide(s); and/or hydrophobic interactions; and/or calcium phosphate crosslinks.

The connectivity (alternatively referred to as link density) can be measured as detailed in the examples. The average β-casein connectivity is preferably equal to or more than 0.5, more preferably equal to or more than 0.52, and/or the average αs₁-casein connectivity is preferably equal to or more than 0.5, more preferably equal to or more than 0.52. Advantageously the average αs₁-casein connectivity can even be equal to or more than 0.6. Most preferably the fermented milk product has an average β-casein connectivity of equal to or more than 0.5, more preferably equal to or more than 0.52, and an average αs₁-casein connectivity of equal to or more than 0.5, more preferably equal to or more than 0.52, most preferably equal to or more than 0.6. There are no upper ranges, but for practical reasons the average β-casein connectivity may be in the range from 0.5 to 0.8, suitably from 0.5 to 0.7 and for practical reasons the average αs₁-casein connectivity may be in the range from 0.5 to 0.8, suitably from 0.6 to 0.7.

The present invention therefore also provides a fermented milk product, wherein the fermented milk product comprises:
protein molecules, preferably casein molecules, that are fused or otherwise associated or connected to each other, preferably with the help of or via capsular, preferably negatively charged, exopolysaccharide(s); and/or hydrophobic interactions; and/or calcium phosphate crosslinks;
capsular, preferably negatively charged, exopolysaccharide(s); and
non-capsular, preferably neutral, exopolysaccharide.
   Other preferences are as described further above or below in this specification.

Without wishing to be bound by any kind of theory, it is believed that around the isoelectric pH of casein (i.e. around a pH of 4.6), negatively charged (i.e. anionic) exopolysaccharides can have attractive electrostatic interactions with positively charged casein micelles. This may for example destabilize the casein dispersion by bridging flocculation, because they may adsorb simultaneously onto multiple casein micelles. The electrostatic interactions with the negatively charged exopolysaccharides may strengthen the final protein network and result in smaller pores. Neutrally charged exopolysaccharides may not be electrostatically attracted to the casein micelles. These non-adsorbing neutral exopolysaccharides may increase the serum viscosity and may accelerate casein aggregation via depletion effects.

Again, without wishing to be bound by any kind of theory, it is believed that the negatively charged capsular exopolysaccharides may cause a higher degree of interconnectivity of the αs1- and β-caseins, whereas in the presence of neutral free (i.e. non-capsular) exopolysaccharides, the size of protein domains may be increased. Advantageously, a fermented milk product, such as a yoghurt, containing both types of exopolysaccharide may exhibit both of these microstructural features as well as high gel stiffness and a low visual serum separation (i.e. a low syneresis).

Determination and analysis of the fermented milk product can be carried out with a technique called direct Stochastic Optical Reconstruction Microscopy (dSTORM). A more detailed explanation of this technique can be found in the article by Pujals et al., titled “Super-resolution microscopy as a powerful tool to study complex synthetic materials”, published in Nature Reviews Chemistry (2019), vol. 3 (2), pages 68-84. In addition, analysis of individual casein micelles can be carried out with such dSTORM imaging as described in the publication by Foroutanparsa et al., titled “Super resolution microscopy imaging of pH induced changes in the microstructure of casein micelles”, published in food structure journal (2021). For example, casein micelles in a solution prepared with milk protein concentrate can be imaged at two acidic pH values (5.5 and 4.5) representing pH conditions of yoghurt processing. Additionally, for the purpose of comparison, micelles can be characterized at higher pH values (pH 7, 7.5 and 8.3). Image acquisition can subsequently be performed using direct Stochastic Optical Reconstruction Microscopy (dSTORM). In this manner casein micelles can be visualized as a function of pH, via immobilizing and imaging casein micelles with dSTORM whilst using specific fluorophores. Hence, one may combine for example diffraction-unlimited single-molecule localization microscopy (SMLM) approaches, photo-activated localization microscopy (PALM) and stochastic optical reconstruction microscopy (STORM), with stimulated emission depletion (STED) microscopy. The combination of high-resolution imaging techniques will enable one to map out the protein arrangement in the microstructure of dairy gels.

The porous protein structure preferably comprises pores having an individual pore area in the range from 1 to 1000 square micrometer.

Preferably the fermented milk product is a fermented milk product wherein the fermented milk product has a structure wherein equal to or more than 35% of the total pore area consists of pores having an individual pore area of equal to or less than 10 square micrometer. The total pore area herein and the individual pore area herein are preferably cross-sectional pore areas, i.e. the pore area in square micrometers as determined on a cross-section of the fermented milk product.

More preferably the fermented milk product has a structure wherein equal to or more than 35%, more preferably equal to or more than 40%, and most preferably equal to or more than 45%, of the total pore area consists of pores having an individual pore area of equal to or less than 10 square micrometer. Suitably the percentage of the total pore area consisting of pores having an individual pore area of equal to or less than 10 square micrometer can be equal to or less than 100%, more suitably equal to or less than 90%, even more suitably equal to or less than 80% and still more suitably equal to or less than 70%.

The fermented milk product further preferably has a structure wherein equal to or more than 75% of the total pore area consists of pores having an individual pore area of equal to or less than 50 square micrometer.

In addition, preferably the percentage of the total pore area consisting of pores having an individual pore area in the range of equal to or more than 100 square micrometer to equal to or less than 1000 square micrometer, lies in the range from equal to or more than 0%, suitably from equal to or more than 1% to equal to or less than 25%, more preferably equal to or less than 20%, and most preferably equal to or less than 15%.

Any remainder of the total pore area may suitably consist of pores having an individual pore area in the range of equal to or more than 10 square micrometer to equal to or less than 100 square micrometer.

Pore area in square micrometers (for example after taking a cross-section of the fermented milk product) can be determined as illustrated in the examples.

The porous protein structure can be determined at any point in time. Preferably the structure is determined once the pH has reached the isoelectric point of the caseins, for example at the onset of gelation or at the end of fermentation, preferably within 6 to 20 hours, more preferably within 6 to 8 hours after the start of fermentation.

The total pore area and the percentage of the total pore area consisting of pores having a certain individual pore area within the specified ranges can be determined in any manner known to a person skilled in the art to be suitable therefore. Suitably the total pore area and the percentage of the total pore area consisting of pores having an individual pore area within the specified ranges can be determined by means of confocal microscopy and/or the techniques as applied in the examples. An example of a method that could be used to determine the pore area distribution is via quantitative image analysis with confocal microscopy, for example via visualization of the exopolysaccharides in a solution of milk protein concentrate with confocal microscopy and analysis of the pore area distribution. A more detailed explanation of this technique can be found in the poster presentation by Bruls et al., titled “Quantitative image analysis of influence_exopolysaccharides during acid milk gel formation”, as presented on the Dutch BioPhysics conference on 12 Oct. 2021, incorporated herein by reference.

Preferably the fermented milk product is a fermented milk product obtained or obtainable by a process comprising the fermentation of a milk base in the presence of:
a first, capsular, preferably negatively charged, exopolysaccharide producing lactic acid bacterial strain; and
a second, non-capsular, preferably neutral (i.e. non-charged), exopolysaccharide producing lactic acid bacterial strain,
   wherein preferably the weight ratio of the first exopolysaccharide producing lactic acid bacterial strain to the second exopolysaccharide producing lactic acid bacterial stain lies in the range from equal to or more than 1:10 to equal to or less than 1000:1, more preferably in the range from equal to or more than 1:1 to equal to or less than 100:1, and most preferably in the range from equal to or more than 10:1 to equal to or less than 100:1.

Hence, preferably the fermented milk product is a fermented milk product comprising a porous protein network, more preferably a porous casein network; a first, capsular, preferably negatively charged, exopolysaccharide; and a second, non-capsular, preferably neutral, exopolysaccharide, wherein the fermented milk product has a structure wherein equal to or more than 35% of the total pore area consists of pores having an individual pore area of equal to or less than 10 square micrometer. Without wishing to be bound by any kind of theory, it is believed that the specific interaction of casein proteins, first exopolysaccharide and second exopolysaccharide during fermentation allows for the unique structure to be formed.

Some lactic acid bacteria produce capsular exopolysaccharides and other lactic acid bacteria produce non-capsular (i.e. unattached) exopolysaccharides.

It is herein understood that the capsular exopolysaccharides are extracellular polysaccharides that are associated with, and can even be covalently bound to, the cell surface of lactic acid bacteria. They can be visible around the lactic acid bacterial cell in the form of “capsules”. The capsular exopolysaccharides can be referred to herein in their abbreviated form as “CEPS” or “CPS”.

The non-capsular exopolysaccharides are herein also referred to as unattached exopolysaccharides. It is herein understood that these non-capsular exopolysaccharides are not associated or attached to the cell surface of a lactic acid bacterial cell. They can float free through the milk base or other fermentation medium at the start of the fermentation. The non-capsular exopolysaccharides can be referred to herein in their abbreviated form as simply “EPS”.

Exopolysaccharides produced by lactic acid bacteria can further be subdivided into two groups, namely homopolysaccharides (HoPS) and heteropolysaccharides (HePS).

Homopolysaccharides are composed of one type of constituting monosaccharides (for example d-glucopyranose or d-fructofuranose) (see for example the article of Monsan et al., titled “Homopolysaccharides from lactic acid bacteria”, published in the International Dairy Journal (2001), Vol. 11, pages 673-683).

Heteropolysaccharides are composed of multiple types of constituting monosaccharides, derivatives of monosaccharides and/or substituted monosaccharides. Preferably the exopolysaccharides referred to in this specification are heteropolysaccharides. Heteropolysaccharides can suitably comprise a backbone of repeated subunits, that are branched (for example at positions C2, C3, C4, C5 or C6) or unbranched. Heteropolysaccharides can suitably comprise or consist of two or more, preferably three to eight monosaccharides, derivatives of monosaccharides and/or substituted monosaccharides. (see for example the article of Vaningelgem et al., titled “Biodiversity of Exopolysaccharides Produced by Streptococcus thermophilus Strains Is Reflected in Their Production and Their Molecular and Functional Characteristics”, published in Applied and Environmental Microbiology (2004), vol. 70 (2), pages 900-912; and the article of De Vuyst et al., titled “Recent developments in the biosynthesis and applications of heteropolysaccharides from lactic acid bacteria” published in the International Dairy Journal (2001), vol. 11, pages 687-707, both incorporated herein by reference).

The protein domain size distribution can be indicative of the porous protein network. The fermented milk product preferably has a protein domain size distribution wherein equal to or more than 10%, more preferably equal to or more than 15% of the total count lies within a range from equal to or more than 1.0 to equal to or less than 1.5 micrometres. A protein domain size distribution can be determined as exemplified in the examples.

### Capsular Exopolysaccharide

The capsular, preferably negatively charged, exopolysaccharide can be added ex-situ or can be produced in-situ. Preferably the capsular, preferably negatively charged, exopolysaccharide is produced in-situ, preferably during fermentation, preferably by lactic acid bacterial strain, more preferably a mesophilic lactic acid bacterial strain, as described in more detail below. In-situ generation of the capsular, preferably negatively charged, exopolysaccharide is more economic. In addition, it is desirable from a customer perspective to limit the addition of additives. Additives can be perceived by customers as artificial and are therefore less desirable.

The capsular, preferably negatively charged, exopolysaccharide is preferably a heteropolysaccharide. More preferably the capsular exopolysaccharide comprises or consists of multiple repeats of a repeating unit, which repeating unit comprises two or more, preferably three to eight, different types of monosaccharides, derivatives of monosaccharides and/or substituted monosaccharides. Preferably at least one of the monosaccharides, derivatives of monosaccharides and/or substituted monosaccharides within the repeating unit is negatively charged. This capsular exopolysaccharide, respectively capsular heteropolysaccharide, can for example become negatively charged via the presence of a phosphate group, pyruvate group or uronic acid group, such as glucuronic acid. Preferably the capsular exopolysaccharide is a heteropolysaccharide comprising a D-glucopyranuronic acid (i.e. glucuronic acid). Suitably such a negative charge is preferably at least present at the start of the fermentation. More preferably the capsular exopolysaccharide, is a negatively charged heteropolysaccharide that maintains its negative charge during fermentation, respectively acidification. That is, more preferably the capsular exopolysaccharide is present in the fermented milk product in the form of a negatively charged heteropolysaccharide.

The capsular, exopolysaccharide preferably has a molecular weight of equal to or more than 100 kiloDalton (kD), more preferably equal to or more than 200 kD, even more preferably equal to or more than 300 kD, still more preferably equal to or more than 400 kD and most preferably equal to or more than 500 kD. There is no upper limit, but for practical reasons the capsular exopolysaccharide preferably has a molecular weight of equal to or less than 1000000 kD, more preferably equal to or less than 100000 kD, and possibly even equal to or less than 10000 kDa, 5000 kD or even 4000 kD. The molecular weight of the capsular exopolysaccharide is defined herein as an averaged molecular weight. The molecular weight of the capsular exopolysaccharide will suitably have a distribution of molecular weight around the averaged molecular weight. The averaged molecular weight, and suitably the weight average molecular weight (Mw), may be determined by the skilled person by methods known in the art, for instance size exclusion chromatography.

The capsular, preferably negatively charged, exopolysaccharide can be branched or non-branched. Preferably the capsular, preferably negatively charged, exopolysaccharide comprises equal to or less than 4, more preferably equal to or less than 3, more preferably equal to or less than 2 branches, per repeating unit. It is also possible for the capsular, preferably negatively charged, exopolysaccharide to have no branches, for example by comprising a repeating unit without branches.

### Non-Capsular Exopolysaccharide

The non-capsular, preferably neutral, exopolysaccharide can be added ex-situ or can be produced in-situ. Preferably the non-capsular, preferably neutral, exopolysaccharide is produced in-situ, preferably during fermentation, preferably by lactic acid bacterial strain, more preferably a thermophilic lactic acid bacterial strain, as described in more detail below. In-situ generation of the non-capsular, preferably neutral, exopolysaccharide is more economic. In addition, it is desirable from a customer perspective to limit the addition of additives. Additives can be perceived by customers as artificial and are therefore less desirable.

The non-capsular, preferably neutral, exopolysaccharide is preferably a heteropolysaccharide. More preferably the non-capsular exopolysaccharide comprises or consists of multiple repeats of a repeating unit, which repeating unit comprises two or more, preferably three to eight, different types of monosaccharides, derivatives of monosaccharides and/or substituted monosaccharides. Preferably the monosaccharides, derivatives of monosaccharides and/or substituted monosaccharides within the repeating unit are all neutral and preferably none of these is negatively charged. This non-capsular heteropolysaccharide preferably does not comprise any negatively charged group. That is, preferably the non-capsular exopolysaccharide, respectively the non-capsular heteropolysaccharide, does not comprise any phosphate group, pyruvate group or uronic acid such as glucuronic acid. Suitably such a negative charge is preferably at least present at the start of the fermentation. More preferably the non-capsular exopolysaccharide, is a neutral heteropolysaccharide that maintains its neutrality during fermentation, respectively acidification. That is, more preferably the non-capsular exopolysaccharide is present in the fermented milk product in the form of a neutral heteropolysaccharide.

The non-capsular exopolysaccharide preferably has a molecular weight of equal to or more than 100 kiloDalton (kD), more preferably equal to or more than 200 kD, even more preferably equal to or more than 300 kD, still more preferably equal to or more than 400 kD and most preferably equal to or more than 500 kD. There is no upper limit, but for practical reasons the non-capsular exopolysaccharide preferably has a molecular weight of equal to or less than 1000000 kD, more preferably equal to or less than 100000 kD, and possibly even equal to or less than 10000 kDa, 5000 kD or even 4000 kD. The molecular weight of the non-capsular exopolysaccharide is defined herein as an averaged molecular weight. The molecular weight of the non-capsular exopolysaccharide will suitably have a distribution of molecular weight around the averaged molecular weight. The averaged molecular weight, and suitably the weight average molecular weight (Mw), may be determined by the skilled person by methods known in the art, for instance size exclusion chromatography.

Most preferably the non-capsular, preferably neutral, exopolysaccharide is a heteropolysaccharide as described in WO2015067559A1 and most preferably the fermented milk product comprises a heteropolysaccharide as described in WO2015067559A1. Hence, preferably the non-capsular, preferably neutral, exopolysaccharide is a heteropolysaccharide characterized in that it is substantially composed of the monosaccharides glucose and galactose and rhamnose and N-acetylgalactosamine, wherein the heteropolysaccharide preferably has a molecular weight of 100 kDa to 100000 kDa, more preferably 100 kDa to 10000 kDa, and even more preferably of 400 kDa to 10000 kDa or of 400 kDa to 4000 kDa. More preferably the non-capsular exopolysaccharide is a heteropolysaccharide substantially composed of the monosaccharides glucose and galactose and rhamnose and N-acetylgalactosamine, which heteropolysaccharide is preferably characterized in that it comprises or is composed of a basic repeating unit whereby the repeating unit is a pentasaccharide composed of the monosaccharides glucose and galactose and rhamnose and N-acetylgalactosamine, wherein the pentasaccharide preferably has the following composition: glucose:galactose:rhamnose:N-acetylgalactosamine=2:1:1:1. Further preferences for the non-capsular, preferably neutral, exopolysaccharide are described in WO2015067559A1. The description and preferences of the heteropolysaccharide described in WO2015067559A1 are herein incorporated by reference.

The non-capsular, preferably neutral, exopolysaccharide, is preferably, partly or wholly, contained in the pores of the porous protein network. Preferably equal to or more than 50% by volume, more preferably equal to or more than 70% by volume of such non-capsular exopolysaccharide is located within the pores of the porous protein network.

The non-capsular, preferably neutral (i.e. uncharged), exopolysaccharide can be branched or non-branched. Preferably the non-capsular, preferably neutral (i.e. uncharged), exopolysaccharide comprises between 0 and 4, more preferably between 1 and 4 branches per repeating unit. It is also possible for the non-capsular, preferably neutral, exopolysaccharide to have no branches, for example by comprising a repeating unit without branches.

### Alternative Fermented Milk Product

In view of the above, the current invention also provides:
(i) A fermented milk product comprising:
   a porous protein network;
   a first, negatively charged, preferably capsular, exopolysaccharide, that is preferably associated with or incorporated in the porous protein network; and
   a second, neutral, preferably non-capsular exopolysaccharide, that is preferably, partly or wholly, contained in the pores of the porous protein network.
(ii) The fermented milk product according to (i), wherein the porous protein network comprises or consists of one or more casein proteins.
(iii) The fermented milk product according to (i) or (ii), wherein the porous protein network comprises or consists of a porous casein network, more preferably a porous alpha-casein network and/or beta-casein network and/or an intertwined alpha-casein and beta-casein network.
(iv) The fermented milk product according to any one of (i) to (iii), wherein the first exopolysaccharide and/or the second exopolysaccharide is/are (a) heteropolysaccharides.
(v) The fermented milk product according to any one of (i) to (iv), wherein the porous protein network, respectively the porous casein network, comprises a structure wherein equal to or more than 35% of the total pore area consists of pores having a pore area of equal to or less than 10 square micrometer.

Further preferences as detailed above and below apply mutatis-mutandis.

### Starter Culture

The fermented milk products according to the invention can advantageously be prepared by using the starter culture according to the invention.

The invention provides a starter culture comprising a first, capsular exopolysaccharide producing, lactic acid bacterial strain and second, non-capsular exopolysaccharide producing, lactic acid bacterial strain,
wherein the first exopolysaccharide is a, preferably negatively charged, preferably mesophilic, capsular, exopolysaccharide; and
wherein the second exopolysaccharide is a, preferably neutral, preferably thermophilic, non-capsular, exopolysaccharide; and
wherein preferably the weight ratio of the first, capsular exopolysaccharide producing, lactic acid bacterial strain to the second exopolysaccharide producing lactic acid bacterial stain in the starter culture lies in the range from equal to or more than 1:10 to equal to or less than 1000:1, more preferably in the range from equal to or more than 1:1 to equal to or less than 100:1, and most preferably in the range from equal to or more than 10:1 to equal to or less than 100:1.

Preferably the lactic acid bacterial strain(s) is/are selected from the group consisting of Lactobacillus spp., Bifidobacterium spp., Streptococcus spp., Lactococcus spp. Leuconostoc spp., Pediococcus spp. and Propionobacterium spp.

More preferably, the lactic acid bacterial strain(s) is/are selected from the group consisting of Lactobacillus delbruekii subsp. bulgaricus, Streptococcus (salivarius) thermophilus, Lactobacillus lactis, Bifidobacterium animalis, Lactococcus lactis, Lactobacillus casei, Lactobacillus plantarum, Lactobacillus helveticus, Lactobacillus acidophilus Bifidobacterium breve and/or combinations thereof.

The first, capsular exopolysaccharide producing, lactic acid bacterial strain (herein also referred to as the “first lactic acid bacterial strain”) is preferably producing a negatively charged, capsular, exopolysaccharide. Preferably the first exopolysaccharide producing lactic acid bacterial strain is a mesophilic strain. More preferably the first exopolysaccharide producing lactic acid bacterial strain is a Lactobacillus delbruekii subsp. bulgaricus strain, a Streptococcus thermophilus strain or a Lactococcus lactis strain. Most preferably first exopolysaccharide producing lactic acid bacterial strain is a Lactococcus lactis strain, more preferably a Lactococcus lactis biovar diacetylactis strain.

An example of a suitable strain that can be used to produce the first, capsular, exopolysaccharide is the L. Lactis B625 strain referred to in patent publication EP2165608.

The second, non-capsular exopolysaccharide producing, lactic acid bacterial strain (herein also referred to as the “second lactic acid bacterial strain”) is preferably producing a neutral (i.e. a neutrally charged or non-charged), non-capsular, exopolysaccharide. Preferably the second exopolysaccharide producing lactic acid bacterial strain is a thermophilic strain. More preferably the second exopolysaccharide producing lactic acid bacterial strain is a Lactobacillus delbruekii subsp. bulgaricus strain, a Streptococcus thermophilus strain or a Lactococcus lactis strain. Most preferably second exopolysaccharide producing lactic acid bacterial strain is a Streptococcus thermophilus strain.

Preferred second exopolysaccharide producing lactic acid bacterial strains include:
the Streptococcus salivarius thermophilus NGB-22D, deposited on 28 Feb. 2012 as CBS132067 at the Centraalbureau voor Schimmelcultures (Fungal Biodiversity Centre), Utrecht; and
the Streptococcus salivarius thermophilus DS65008, deposited on 18 Jun. 2013 as CBS135685 at the Centraalbureau voor Schimmelcultures (Fungal Biodiversity Centre), Utrecht.

In addition to the first exopolysaccharide producing lactic acid bacterial strain and the second exopolysaccharide producing lactic acid bacterial strain, one or more additional, other, lactic acid bacterial strains can be present. These additional lactic acid bacterial strains may or may not be exopolysaccharide producing strains. For example, in addition to the first exopolysaccharide producing lactic acid bacterial strain and the second exopolysaccharide producing lactic acid bacterial strain, the starter culture may or may not comprise a Lactobacillus delbrueckii subsp. bulgaricus stain, a Lactobacillus acidophilus strain, a Lactobacillus casei strain and/or a strain of Lactococcus lactis spp. lactis and/or Lactococcus lactis spp. cremoris.

More preferably the starter culture comprises:
a first, preferably negatively charged, preferably capsular, exopolysaccharide producing Lactococcus lactis biovar diacetylactis strain; and
a second preferably negatively charged, preferably non-capsular, exopolysaccharide producing Streptococcus thermophilus strain; and
optionally a Lactobacillus delbrueckii subsp. bulgaricus stain wherein preferably the weight ratio of the first exopolysaccharide producing exopolysaccharide producing Lactococcus lactis biovar diacetylactis strain to the second exopolysaccharide producing Streptococcus thermophilus strain in the starter culture lies in the range from equal to or more than 1:10 to equal to or less than 1000:1, more preferably in the range from equal to or more than 1:1 to equal to or less than 100:1, and most preferably in the range from equal to or more than 10:1 to equal to or less than 100:1.

Preferably the starter culture comprises a total weight of lactic acid bacteria in the range from equal to or more than 0.01% by weight (w/w), more preferably equal to or more than 0.1% (w/w), even more preferably equal to or more than 1.0% (w/w) and still more preferably equal to or more than 2.0% (w/w) or even equal to or more than 5.0% (w/w) or equal to or more than 10.0% (w/w) to equal to or less than 100.0% (w/w), more preferably equal to or less than 90.0% (w/w), even more preferably equal to or less than 80.0% (w/w) and possibly equal to or less than 70.0% (w/w) or even equal to or less than 60.0% (w/w) or equal to or less than 50.0% (w/w), based on the total weight of the starter culture.

The remainder of the starter culture can comprise one or more other compounds or materials, such as for example fillers, excipients or protectants, such as cryoprotectants and/or lyoprotectants. These compounds or materials can be added to ensure or increase the stability of the lactic acid bacterial strain(s) or the enzyme(s), for example during long term storage or that are added to improve disability or flowability. Cryoprotectants and/or lyoprotectants can be used to protect the lactic acid bacteria and/or the from damage during freezing and thawing, respectively during freeze-drying. Such a cryoprotectant, respectively lyoprotectant, may be any additive as long as it protects the lactic acid bacterial cells or the enzyme from damage during freezing and thawing, respectively freeze-drying.

Suitable excipients and/or protectants include proteins, carbohydrates including monosaccharides (e.g. galactose, glucose, fructose, D-mannose, sorbose), disaccharides (e.g. lactose, trehalose, sucrose), polysaccharides (e.g. raffinose, starch, gums, celluloses, maltodextrin, cyclodextrin, dextran), polyalcohols (e.g. glycerol, sorbitol, mannitol), polyethers (e.g. polypropylene glycol, polyethylene glycol, polybutylene glycol), antioxidants (e.g. natural antioxidants such as ascorbic acid, beta-carotene, vitamin E, glutathione, chemical antioxidants), oils (e.g. rapeseed oil, sunflower oil, olive oil), surfactants (e.g. Tween® 20, Tween® 80, fatty acids), peptones (e.g. soy peptones, wheat peptone, whey peptone), tryptones, vitamins, minerals (e.g. iron, manganese, zinc), hydrolysates (e.g. protein hydrolysates such as whey powder, malt extract, soy), amino acids (e.g. monosodium glutamate, glycine, alanine, arginine, histidine), nucleobases (e.g. cytosine, guanine, adenine, thymine, uracil, xanthine, hypoxanthine, inosine), yeast extracts (e.g. yeast extracts of Saccharomyces spp., Kluyvermomycesa spp., or Torula spp.), beef extract, growth factors, and lipids and combinations of all of these.

Preferably, the starter culture has a content of viable lactic acid bacterial cells of at least 1×10⁷ colony forming units (cfu) per gram (g) starter culture, more preferably at least 1×10⁸ cfu/g, more preferably at least 1×10⁹ cfu/g, even more preferably at least 1×10¹⁰ cfu/g, still more preferably at least 1×10¹¹ cfu/g, yet even more preferably at least 1×10¹² cfu/g and most preferably at least 1×10¹³ cfu/g starter culture. The advantage of such high concentrations of lactic acid bacteria in the starter culture is that small amounts of starter culture are sufficient for the inoculation of large amounts of milk base.

The invention advantageously provides a novel use of a starter culture as described above for the production of a fermented milk product.

### Fermenting

The invention further provides a process for the production of a fermented milk product comprising the fermentation of a milk base in the presence of a first exopolysaccharide producing lactic acid bacterial strain and a second exopolysaccharide producing lactic acid bacterial strain, wherein the first exopolysaccharide is a, preferably negatively charged, preferably capsular, exopolysaccharide; and wherein the second exopolysaccharide is a, preferably neutral, preferably non-capsular, exopolysaccharide; and
wherein preferably the weight ratio of the first exopolysaccharide producing lactic acid bacterial strain to the second exopolysaccharide producing lactic acid bacterial stain in the starter culture lies in the range from equal to or more than 1:10 to equal to or less than 1000:1, more preferably in the range from equal to or more than 1:1 to equal to or less than 100:1, and most preferably in the range from equal to or more than 10:1 to equal to or less than 100:1. During the fermentation, the milk base can be acidified.
   The process according to the invention can advantageously be applied to produce a wide range of fermented milk products. Examples of suitable fermented milk products include various types of yoghurt (such as set yoghurt, stirred yoghurt, low fat yoghurt, non-fat yoghurt), kefir, dahi, ymer, buttermilk, butterfat, sour cream and sour whipped cream as well as fresh cheeses such as quark and cottage cheese.

Suitable examples of milk base that can be applied in the process according to the invention were already provided in the section definitions. The milk base may be adjusted to arrange for the desired amounts of fat and/or proteins. If so desired, stabilizers and/or other additives may be added. However, advantageously, the process according to the invention allows one to produce a fermented milk product having a desirable non-ropy structure (i.e. a “short” structure) and/or a firm acid gel without applying the additives of the prior art. Therefore preferably the process is carried out in the absence of, for example, sodium hydroxide (NaOH) and/or other pH regulators.

Suitably a milk is used wherein equal to or more than 50% w/w, more preferably equal to or more than 60% w/w, even more preferably equal to or more than 70% and most preferably equal to or more than 80% of the protein in the milk is casein. For practical reasons the percentage of casein in the milk may be equal to or less than 100% w/w, suitably equal to or less than 99% w/w of the protein in the milk. As indicated before, a preferred milk base for use in the invention is a milk base from a bovine source. Milk from a bovine source can comprise a casein percentage wherein equal to or more than 80% of the protein in the milk is casein.

Preferably the casein-to-whey weight ratio in the milk base lies in the range from 70:30 to 90:10. More preferably in the range from 75:25 to 85:15.

The process conditions during such acidification, respectively fermentation, can be varied widely.

The milk base is preferably heated before fermentation thereof. More preferably the milk base is heated at a temperature equal to or more than 80° C., more preferably a temperature equal to or more than 85° C., for a period of preferably equal to or more than 20 minutes, more preferably equal to or more than 30 minutes. In the alternative or in addition, the milk base may be heated at a temperature of equal to or more than 95° C., preferably for a period of equal to or more than 10 minutes. The heat treatments advantageously allow for the elimination of pathogens. In addition, the heat treatments can help to create a better environment for the lactic acid bacterial cells to grow. That is, the heat treatment allows the whey proteins to denature and precipitate on the caseins. Without wishing to be bound by any kind of theory it is believed that this may help to improve texture build-up during fermentation.

Optionally the milk base can be homogenized (e.g. stirred or mixed) before fermentation. Without wishing to be bound by any kind of theory, such homogenization may allow for an improved consistency of the fermented milk product.

After heating and before inoculation of the milk base with the lactic acid bacterial strain(s), the milk base is preferably cooled to the desired fermentation temperature. More preferably the temperature of the milk base is adjusted to a fermentation temperature in the range from equal to or more than 18° C., preferably equal to or more than 22° C. to equal to or less than 45° C., more preferably equal to or less than 42° C.

Preferably the first, capsular exopolysaccharide producing, lactic acid strain is a mesophilic strain and the second, non-capsular exopolysaccharide producing, lactic acid strain is a thermophilic strain. In such a case fermentation is preferably carried out in the range from equal to or more than 35° C. to equal to or less than 40° C., more preferably out in the range from equal to or more than 36° C. to equal to or less than 39° C.

Fermentation of the milk base can suitably be carried out in a so-called fermentation vat or fermentation tank.

The milk base can be inoculated with the starter culture in any manner known by the person skilled in the art. For example, the starter culture can be dosed batchwise, semi-batchwise or continuously, including for example by inline dosing.

Although the temperature can be adjusted during fermentation, the temperature during fermentation is preferably kept constant. Preferably a constant fermentation temperature is chosen in the range from equal to or more than 18° C., preferably equal to or more than 22° C. to equal to or less than 45° C., more preferably equal to or less than 42° C. During the fermentation the pH decreases. Preferably the fermentation is continued until a certain desired pH, preferably a pH in the range from equal to or more than pH 4.0 to equal to or less than pH 4.8, is reached. More preferably the fermentation is at least continued for a certain period of time until a pH of for example pH 4.8, pH 4.7, pH 4.6, pH 4.5, pH 4.4, pH 4.3, pH 4.2, pH 4.1 or pH 4.0 is reached. The time period until the desired pH is reached is herein also referred to as “acidification time”. The use of the starter culture according to the invention advantageously allows one to shorten the acidification time, whilst still obtaining a fermented milk without excessive syneresis. That is, the use of the advantageously allows one to reach the same pH in a shorter time period or, alternatively, allows one to reach a lower pH in the same time period. Preferably the time to reach a pH of for example pH 4.6 is equal to or less than 10 hours, more preferably equal to or less than 8 hours, even more preferably equal to or less than 7 hours and most preferably equal to or less than 6 hours.

In the process according to the invention, the time period during which the milk base is fermented (the “fermentation time”) can therefore advantageously be equal to or less than 22 hours, more preferably equal to or less than 20 hours, still more preferably equal to or less than 18 hours, even more preferably equal to or less than 16 hours, still even more preferably equal to or less than 14 hours or even equal to or less than 12 hours. More preferably the milk base is fermented during a time period that is equal to or less than 10 hours, still more preferably equal to or less than 8 hours, even more preferably equal to or less than 7 hours and most preferably equal to or less than 6 hours. Hence advantageously the time period for the fermentation of the milk base in the process according to the invention can lie in the range from equal to more than 3 hours, more preferably equal to or more than 4 hours, still more preferably equal to or more than 5 hours, to equal to or less than 12 hours, more preferably equal to or less than 10 hours, even more preferably equal to or less than 8 hour, still more preferably equal to or less than 7 hours and most preferably equal to or less than 6 hours.

When the desired pH is reached, the fermentation can be stopped in any manner known to the person skilled in the art. Preferably the fermentation is stopped by cooling the fermented milk product, for example by reducing the temperature to a temperature equal to or less than 10° C., more preferably equal to or less than 8° C., and most preferably equal to or less than 7° C. The fermented milk product can suitably be removed from the fermentation vat or fermentation tank.

Optionally the fermented milk product can be stirred and/or fruit and/or flavors can be added to the fermented milk product. Subsequently the fermented milk product can be packaged as desired.

In a possible embodiment, the process is carried out as a two-step process where the steps are the reverse of those mentioned in U.S. Pat. No. 7,323,199B.

The invention therefore also provides a process for the production of a fermented milk product comprising:
a) an inoculation step comprising inoculation of a milk base with a starter culture comprising a first exopolysaccharide producing lactic acid bacterial strain and a second exopolysaccharide producing lactic acid bacterial strain, wherein the first exopolysaccharide is a, preferably negatively charged, preferably capsular, exopolysaccharide and the second exopolysaccharide is a, preferably neutral, preferably non-capsular, exopolysaccharide;
b) an acidification step to allow fermentation, acidification and/or clotting of the milk base; and
c) a subsequent exopolysaccharide production step.
   During step c) the pH may be kept constant or may be allowed to vary, for example, by 0.01 to 0.5 pH points.

Preferences for the starter culture and the lactic acid bacterial strains are as described herein above. The first exopolysaccharide producing lactic acid bacterial strain can be added to the milk base before, after or at the same time as the second exopolysaccharide producing lactic acid bacterial strain. Preferably the first exopolysaccharide producing lactic acid bacterial strain and the second exopolysaccharide producing lactic acid bacterial strain are added to the milk base at the same time, i.e. simultaneously, for example as part of one and the same starter culture.

Preferably the first exopolysaccharide producing lactic acid bacterial strain is dosed in such a manner that the concentration of the first exopolysaccharide producing lactic acid bacterial strain in the milk base at the start of the fermentation lies in the range from equal to or more than 0.01 gram/100 gram, more preferably equal to or more than 0.1 gram/100 gram to equal to or less than 10 gram/100 gram, more preferably equal to or less than 1 gram/100 gram.

Preferably the second exopolysaccharide producing lactic acid bacterial strain is dosed in such a manner that the concentration of the second exopolysaccharide producing lactic acid bacterial strain in the milk base at the start of the fermentation lies in the range from equal to or more than 0.0001 gram/100 gram, more preferably equal to or more than 0.001 gram/100 gram to equal to or less than 0.1 gram/100 gram, more preferably equal to or less than 0.02 gram/100 gram.

### EXAMPLES

The following examples are offered for illustrative purposes only, and are not intended to limit the scope of the present invention in any way.

### Materials and Methods

### Preparation of the Fermented Milk Products, Monitoring of the Acidification Kinetics and Quantification of the Syneresis.

Fresh pasteurized skimmed milk (fat content <0.1%, De Zaanse Hoeve, commercially obtained from supermarket Albert Heijn, The Netherlands) was heated for 15 min. at 90° C., and then heated for 30 min. at 85° C. The heat treated milk was cooled down during about 1 hour to room temperature (approximately 20° C.) and stored overnight at 4° C.

The next day, sodium formate (5 mg/ml), where applicable Rhodamine B (0.1 μg/ml), and 1 w % of NuCel 751 MG yeast extract were added. Subsequently the milk was heated to 37° C. and after 30 minutes the milk was inoculated with a first exopolysaccharide producing strain (“Strain A”) and/or a second exopolysaccharide producing strain (“strain B”).

Strain A was the L. lactis B625 strain, referred to in patent publication EP2165608, a negatively charged, capsular, exopolysaccharide producing Lactococcus lactis biovar diacetylactis strain commercially available from DSM Food Specialities.

Strain B was the neutrally charged, non-capsular exopolysaccharide producing Streptococcus thermophilus strain referred to in WO2015067559A1 as NGB-22D, which Streptococcus salivarius thermophilus NGB-22D was deposited on 28 Feb. 2012 as CBS132067 at the Centraalbureau voor Schimmelcultures (Fungal Biodiversity Centre), Utrecht, and commercially available from DSM Food Specialities.

For the fermentation experiments the inoculated milk was filled out in 250 ml plastic cups and incubated in a water bath at 37° C. In parallel, the pH was continuously recorded using a Cinac system. When a pH of pH 4.6 was reached, the cups were stored at 4° C. To quantify syneresis, the total weight of the cups containing the fermented milk products was recorded. Subsequently, the free serum was isolated by gently decanting it into a pre-weighed empty cup without applying force to the milk gel, and the weight of the free serum was recorded. Syneresis is expressed as the percentage of free serum in the total sample.

For the microstructural characterization, the inoculated milk was quickly transferred to a chambered microscopy slide (chamber volume=500 μl) equipped with integrated heating element (VaHeat, Interherence) which maintains the sample temperature at 37° C. In the timelapse experiments, images were acquired (via confocal laser-scanning microscopy) every minute during a total interval of 8 hours. Finally, ten images per sample were taken of the final network structure, a total of 50 images per sample type.

For the rheology measurements, 3.8 ml of yogurt was added to the rheometer geometry the day after fermentation, and a few oil droplets are added on top to prevent evaporation. The storage and loss modulus are determined in oscillatory mode. A frequency sweep in the range of 100 to 0.1 Hz is taken at constant amplitude (1%). Both the storage modulus (G′), representing the stored deformation energy, also referred to as the elastic modulus, and the loss modulus (G″), representing deformation energy lost, also referred to as the viscous modulus, were determined.

### Rheology

Rheological measurements were performed with a rheometer (Anton Paar GmbH, MCR501) configured and controlled by Rheoplus software (version 3.62) and equipped with double gap cylinder geometry (DG26.7-SN188610). All rheology experiments were performed in triplo.

### Confocal Laser-Scanning Microscopy

Confocal laser-scanning microscopy (CLSM, Leica SP8) was performed in the inverted mode with a 100× oil-immersion objective. The pixel size was set to 80 nm, using 0.75 digital zoom to generate images of 1936×1936 pixels. Samples were excited with an incident laser at 552 nm with detection between 565 and 630 nm. All images were taken >10 μm from the glass interface to avoid boundary anomalies in the gel formation.

### Pore Size Distribution Analysis

The wording pore and void can be used interchangeably herein. Prior to image analysis, the images are rescaled to maximize contrast using the automatic brightness adjustment function in software program ImageJ (ImageJ is a public domain Java image processing and analysis program). Further image analysis was conducted with software program Python™ 2 (Python™ is freely usable and distributable, and is administered by the Python Software Foundation.) using inbuilt functions for area calculation, Fourier transformation and additional custom-made functions. To calculate the pore size distribution, a wiener smoothing filter of 5×5 pixels was applied to the images using the SciPy function ‘wiener’. Images were then thresholded and transformed into 8-bit binary images, with 0.7×the mean grey level as threshold. The pore areas are calculated using the python function ‘cv2.findcontours’, which uses an algorithm that is explained by Satoshi Suziki et al. in their article titled “Topological structural analysis of digitized binary images by border following”, published in Comput. Vision, Graph. Image Process. (1985) Vol. 30, pages 32-46. [2]. Pores which contain one or more pixels at the image border were excluded from analysis, as well as pores with an area smaller than 100 pixels (0.65 μm²).

The protein domain size analysis was carried out as follows:
Protein domain size was determined by autocorrelation image analysis. The autocorrelation was performed according to a method described by Glover et al. as described in their article titled “Super-resolution microscopy and empirically validated autocorrelation image analysis discriminates microstructures of dairy derived gels”, published in Food Hydrocoll (2019), vol. 90, pages 62-71.
The autocorrelation G(a,b) of an image was defined as:

$$G ( a , b ) = {\sum }_{x = 1}^{M} {\sum }_{y = 1}^{N} I ( x , y ) \cdot I ( x - a , y - b )$$

where M and N are the number of pixels in the height and width, respectively, (a,b) are the coordinates in the generated autocorrelation image. According to the Wiener-Khinchin theorem⁴, a computationally efficient method to compute the autocorrelation image is to take the inverse Fourier transform of the power spectrum image:

$$S ( I ) = \vert {ℱ [ I ( x , y ) ]}^{2} G ( a , b ) = {ℱ}^{-} [ S ( I ) ]$$

Where S(I) is the power spectrum of the image, and [symbol] represents the Fourier transform and [symbol] ⁻¹ the inverse of the Fourier transform. To limit the influence of variations in intensity over the samples, a normalized autocorrelation g(a,b) is computed by subtraction of the mean intensity, and division by the standard deviation of the image:

$$g ( a , b ) = \frac{1}{{σ ( x , y )}^{2}} {ℱ}^{- 1} [ ℱ [ I ( x , y ) - 〈 I ( x , y ) 〉 ] \cdot {ℱ}^{*} [ I ( x , y ) - 〈 I ( x , y ) 〉 ] ]$$

Where σ(x, y) is the standard deviation of the intensity values of the source image I, [symbol] * denotes the complex conjugate of the Fourier transform and (I(x, y)) is the average intensity in the image. Then, the radial distribution of the autocorrelation and power spectrum images are computed by a custom built python function which calculates for every pixel in the image the distance to the center of the image, and averages the correlation values over the pixels that have the same distance to the center. The radially averaged correlation values were normalized by division by the largest value, which is at the image center. As demonstrated by Ako et al. (see literature list) the radially averaged autocorrelation decay can be fit to a stretched exponential:

$$p ( r ) = C \cdot {e}^{- {( \frac{r}{ξ} )}^{β}}$$

Where C is a constant, β is a value between 1 and 2, and ξ is the characteristic length which in this paper was taken as a measure of the protein domain size. The model p(r) was fit to the radial distribution of the autocorrelation image for each microscopy image using the scipy function ‘curve_fit’, and the value for the characteristic length ξ is extracted.

### Structure Factor Analysis.

The Fourier space analysis were performed according to a method described by Glover et al. in their article titled “Super-resolution microscopy and empirically validated autocorrelation image analysis discriminates microstructures of dairy derived gels”, published in Food Hydrocoll, (2019), vol 90, pages 62-71. The structure factor was determined from the log-log plot of the radially averaged distribution of the power spectrum image. The gradient of the linear region in the log-log plot is the structure factor β. To extract this value, a linear fit was applied to the curve at the steepest part, determined from the minimum value of the derivative plot of a high order polynomial fit to the data.

### Determination of the Onset of Gelation

The onset of gelation was determined from the timelapse experiments. The structure factor was computed for every image in the acquisition. The onset of gelation was taken as the first point in time for which the standard deviation in β of nine neighbouring values is below 0.05.

### Stimulate Emission Depletion (STED) Microscopy

The generation of the STED images was carried out as follows:

### Preparation of a D-(+)-Gluconic Acid δ-Lactone Induced MPC80 Gel for Calibration of the Microstructural Characterization Using STED Microscopy

Milk protein concentrate powder containing 80 wt % protein (MPC80) was obtained from the Hungarian Dairy Research Institute Ltd. During MPC80 powder preparation, milk was subjected to ultrafiltration and subsequent diafiltration to exclusively concentrate protein and casein-bound calcium phosphate (carried out as described in the article by Babella, titled “Scientific and practical results with use of ultrafiltration in Hungary”, published in Int. Dairy Fed (1989), vol. 244, pages 7-24). The retentate was heat treated by direct steam infusion at 130° C. for 20 sec, followed by vacuum evaporation and spray-drying. The composition of the resulting MPC80 powder was 80% milk proteins (comprising a casein-to-whey protein ratio of 80:20, which is similar to milk), 7.5% ash, 5.5% lactose, 5% water and 1.5% fat.

4.5% (w/w) MPC80 was dissolved in ultrapure water (Milli-Q), shaken for 1 hour and kept overnight at 4° C. to be hydrated. The resulting reconstituted milk was heated for 20 minutes at 90° C. and subsequently cooled in ice water for 30 minutes. Following overnight incubation at 4° C., 1.5 wt % D-(+)-gluconic acid δ-lactone (GDL, ≥99.0%, Merck) was added and the sample was incubated overnight at room temperature (RT) to the final pH of ≈4.

### Immobilizing and Labelling Yoghurt

To immobilize yoghurt network onto the surface via electrostatic interactions, cationic poly-L-lysine (PLL, Sigma-Aldrich) was applied to coat the surface. Cover slides were coated with PLL by placing the slides on top of 400 μl of 0.1% (v/v) PLL for 30 min., then washed thoroughly with ultrapure water (Milli-Q). Afterwards, a small piece of yoghurt sample was carefully transferred on the microscope slide taped with two strips of double-sided adhesive tape and PLL-coated coverslip was placed on top to make a flow chamber containing a turbid yoghurt. Sample was incubated inside the chamber upside down at RT for 10 min. Thereafter, for subsequent fixation, 25 ul of 4% (w/v) freshly prepared formaldehyde solution in 10 mM phosphate buffer solution (PBS) was injected in the chamber and incubated upside down at RT for 20 minutes (as described by Babella, in the article titled “Scientific and practical results with use of ultrafiltration in Hungary”, published in Int. Dairy Fed (1989), vol. 244, pages 7-24).

Subsequently, the chamber was rinsed by injecting 200 μl of PBS inside to make it ready for staining. To localize β- and αs1-casein, rabbit anti-bovine β-casein polyclonal antibody (Bioss, ref. BS-10032R) and rabbit anti-bovine αs1-casein polyclonal antibody (Bioss, ref. BS-10033R) were directly labelled with ATTO647N-NHS ester dye (Sigma-Aldrich, ref. 94822), which is a suitable dye for Stimulate emission depletion (STED) microscopy, using protocol described in section below. The dye-conjugated primary antibodies (degree of labelling=3-4.5) were diluted to 200 μg/ml and 25 μl of each was injected into the chambers containing same type of yoghurt and incubated at 4° C. overnight. Following extensive washing with PBS buffer, the chamber was sealed and prepared for Stimulate emission depletion (STED) microscopy.

Labelling Primary Antibodies with Dye

To conjugate antibodies with ATTO647N-NHS ester dye, first (1 mg/ml) antibodies were purified using centrifugal filter units with a 10 000 Da molecular weight cut off (Millipore, ref. UFC5003) to remove Glycerol. Afterwards 0.5 ul of ATTO647N-NHS ester dye (2 mg/ml in Dimethyl sulfoxide) was gradually added to the purified antibody solution (≈500-600 μg/ml in carbonate buffer, pH 8.5). After overnight incubation at 4° C., free dyes were removed from the solution using centrifugal filter units (10 000 Da molecular weight cut off). Final antibody concentration and degree of labelling were determined by spectrophotometric analysis using a NanoDrop spectrophotometer (Thermo Scientific, Rockford, USA).

### Stimulate Emission Depletion (STED) Microscopy

Super resolution imaging was performed using a STED microscope (Abberior Instrument) equipped with UPlanSApo 100×/1,40 Oil [infinity]/0, 17/FN26,5 objective (Olympus), a Katana-08 HP laser (Onefive) and multiple STED laser lines at 405 nm, 488 nm, 561 nm, 640 nm, and the pulsed laser at 595 nm and 775 nm; plus Imspector 0.14.13919 software. The images were acquired from the protein regions in the middle and edges of yoghurt sample within a field of view of 15×15 μm², with pixel size of 30 nm, and a pixel dwell time of 10 μs.

Images were taken ≈1 μm above the coverslip where the structure was fixed and immobilized with the highest signal to noise ratio. A pinhole was set at 1.00 AU at 100×. ATTO647N dye was excited at 640 nm, whereas STED was achieved using a wavelength of 775 nm. 8-bit TIFF STED images were exported for the further image analysis.

### Image Analysis of STED Images: Skeleton Analysis.

A skeleton analysis method was used to quantify caseins (β- and αs₁-caseins) topology in yoghurt gel. All the analysis steps were performed using Fiji/Image J software (https://imagej.net/software/fiji/). For skeleton analysis, first 8-bit STED TIFF images were noise reduced by applying Gaussian filter (radius=2) and then binarized using a threshold of 0.9×mean grey value. The resulting binarized images of protein domains were skeletonized (Fiji, skeleton plugin) to produce one pixel wide representative image (as described by Lee T, in his article titled Building Skeleton Models via 3-D Medial Surface/Axis Thinning Algorithms, published in Graph. Model. Image Process. 56, pp 462-478 (1994)).

Furthermore, the skeletonized images comprising a network of branches were analyzed by AnalyzeSkeleton plugin. (as described by Arganda-Carreras, R. Fernández-González, A. Muñoz-Barrutia, C. Ortiz-De-Solorzano, 3D reconstruction of histological sections: Application to mammary gland tissue, Microsc. Res. Tech. 73 (2010) 1019-1029)

The pixels were classified within the thinned protein domains based on their 26 neighbors into three categories: end-points pixels, which have less than 2 neighbors, junction pixels with more than 2 neighbors and slab pixels which have exactly 2 neighbors. Slab pixels are building blocks of branches that connect end and junction points. Additionally, the possible loops were pruned by cutting the loop branches from its darkest pixel by choosing “lowest intensity voxel” as prune cycle method.

To define the connectivity of skeleton, dangling ends and loop defects were identified within the network. Dangling ends, branches connecting to the end points were eliminated by choosing “Prune Ends” option of the plugin. Branches with Euclidean distance of less than 100 nm (about two times the resolution of STED microscopy) were considered as dangling loops and further removed. Therefore, link density of αs1- and β-caseins in STED images, was obtained for individual images from a ratio of total number of linking branches excluding dangling ends and loops to total number of branches. An ideal, fully connected network, in which all branches are connected via junction points, has no dangling ends and no loop defects. This is termed an ideal end-linked polymer gel and will have link density of 1 (as described by A. M., N. B., L. M., Polymer Gel Rheology and Adhesion, Rheology. (2012). https://doi.org/10.5772/36975).

### Comparative Example A: Production of a Fermented Milk Product with Strain A

A fermented milk product was produced according to the method described in the Materials and Methods above. The skimmed milk was inoculated with an amount of Strain A only in a dosage such that the resulting skimmed milk contained 0.25 grams of strain A per 100 grams of milk to be fermented (0.25 wt %).

Subsequently the pore size distribution was determined with the method as described in the Materials and Methods. The results are summarized in Table 1.

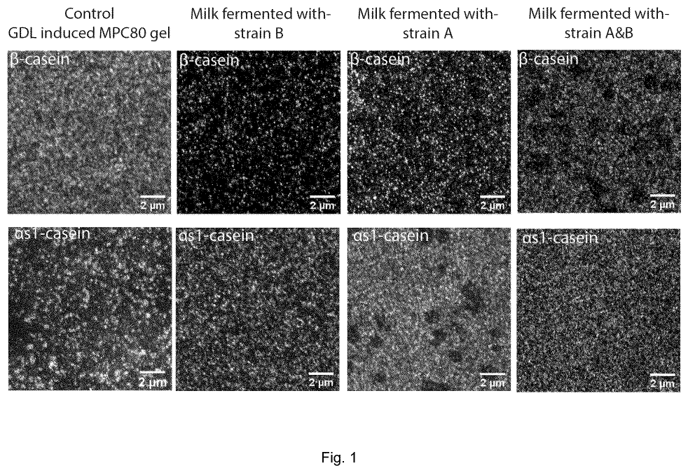

In addition, the protein domain size was determined with the method as described in the Materials and Methods. The results are summarized in Table 2. The β-casein network and the αS1-casein network for this example are illustrated in FIG. 1 (i.e. the 3rd imagines from the left of each row).

Void fractions were determined and calculated as described in the Materials and Methods. The results are summarized in Table 3.

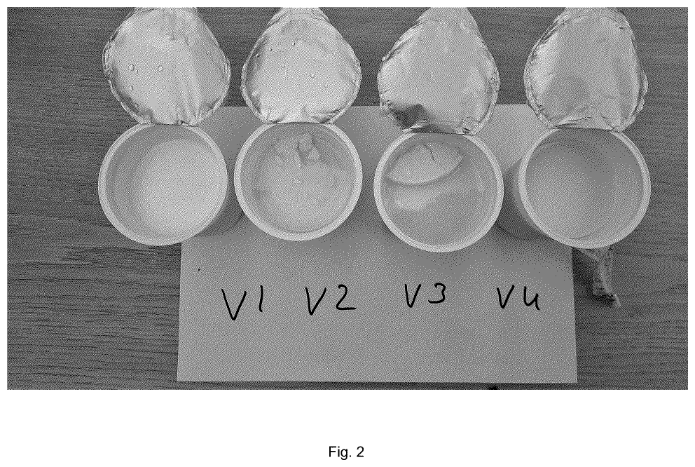

The percentage of syneresis, calculated from the weights of the free serum and the total sample was determined as described in the Materials and Methods. The results are summarized in Table 4. Syneresis is further illustrated by the images in FIG. 2.

In addition the pH after 20 hours of fermentation was determined for the fermented milk products produced. Table 5 displays the time to reach pH 4.6 and the pH after 20 h of fermentation, as obtained from the acidification curves recorded using a Cinac system.

Skeleton analysis of the αs1- and β-caseins was performed to determine the connectivity of the network as described in the Materials and methods. The results are summarized in Table 6.

Rheology was performed as described in the Materials and methods. The results are summarized in Table 7.

### Comparative Example B: Production of a Fermented Milk Product with Strain B

A fermented milk product was produced according to the method described in the Materials and Methods above. The skimmed milk was inoculated with an amount of Strain B only in a dosage such that the resulting skimmed milk contained 0.0075 grams of strain B per 100 grams of milk to be fermented (0.0075 wt %).

Subsequently the pore size distribution was determined with the method as described in the Materials and Methods. The results are summarized in Table 1.

In addition, the protein domain size was determined with the method as described in the Materials and Methods. The results are summarized in Table 2. The β-casein network and the αS1-casein network for this example are illustrated in FIG. 1 (i.e. the 2nd imagines from the left of each row).

Void fractions were determined and calculated as described in the Materials and Methods. The results are summarized in Table 3.

The percentage of syneresis, calculated from the weights of the free serum and the total sample was determined as described in the Materials and Methods. The results are summarized in Table 4. Syneresis is further illustrated by the images in FIG. 2.

In addition the pH after 20 hours of fermentation was determined for the fermented milk products produced. Table 5 displays the time to reach pH 4.6 and the pH after 20 h of fermentation, as obtained from the acidification curves recorded using a Cinac system.

Skeleton analysis of the αs1- and β-caseins was performed to determine the connectivity of the network as described in the Materials and methods. The results are summarized in Table 6.

Rheology was performed as described in the Materials and methods. The results are summarized in Table 7.

### Example 1: Production of a Fermented Milk Product with a Specific Combination of Strain A and Strain B

A fermented milk product was produced according to the method described in the Materials and Methods above. The skimmed milk was inoculated with an amount of Strain A and Strain B in dosages such that the resulting skimmed milk contained 0.25 grams of strain A per 100 grams of milk to be fermented (0.25 wt %) and 0.0075 grams of Strain B per 100 grams of skimmed milk to be fermented (0.0075 wt %)

Subsequently the pore size distribution was determined with the method as described in the Materials and Methods. The results are summarized in Table 1. It was surprisingly found that an effect occurred when the combination of strain A and strain B was used in the fermentation, that was not predictable on the basis of the results of the fermentations with Strain A only and Strain B only. As illustrated by table 1, the use of a combination of strain A and strain B resulted in a structure comprising a substantially increased percentage of smaller pores, having a pore area of less than 10 square micrometer (μm²), as compared to either strain A alone or strain B alone. The increased percentage of smaller pores is indicative of a reduced total pore volume, a more non-ropy like structure (i.e. a “short” structure) and/or a firmer acid gel.

In addition, the protein domain size was determined with the method as described in the Materials and Methods. The results are summarized in Table 2. The results again show a surprising effect, that was not predictable on the basis of the results in comparative examples A and B. When a combination of Strain A and Strain B was used in the fermentation, the percentage of the total count of protein domain size in the range from 0-0.5 micrometre slightly increased vis-à-vis the percentages in comparative examples A and B. More surprisingly the percentage of the total count of protein domain size in the range from 1.0-1.5 micrometre more than doubled vis-à-vis the percentages in comparative examples A and B. The STED images of the β-casein network and the αS1-casein network for this example are illustrated in FIG. 1 (i.e. the last images of each row). The image on the top row is indicative of a porous β-casein network.

Void fractions were determined and calculated as described in the Materials and Methods. The results are summarized in Table 3. The percentage of syneresis, calculated from the weights of the free serum and the total sample was determined as described in the Materials and Methods. The results are summarized in Table 4. Whereas the CPS-producing strain A causes significant syneresis, the combination of CPS-producing strain A and EPS-producing strain B has a syneresis that is only slightly increased compared to EPS producing strain B. The fermented milk product produced by the combination of strain A and B, having a decreased ropiness does therefore not show any excessive syneresis. Syneresis is further illustrated by the images in FIG. 2. The results show that, as compared to comparative example A, the fermented milk product produced by the combination of Strain A and Strain B does not show excessive syneresis.

In addition the pH after 20 hours of fermentation was determined for the fermented milk products produced. Table 5 displays the time to reach pH 4.6 and the pH after 20 h of fermentation, as obtained from the acidification curves recorded using a Cinac system. As can be seen from Table 5, EPS producing strain B has a faster acidification rate, but also suffers from considerable post acidification, resulting in a lower pH after 20 h of fermentation. CEPS producing strain A suffers less from post acidification. Advantageously, the combination of strain A and B results in fermentation kinetics similar to that of strain A alone, with a higher pH after 20 h of fermentation. As the pH after 20 hours of fermentation is indicative of post acidification during shelf-life, it can be concluded that the combination of a CPS-producing strain with an EPS-producing strain results in a desirable mild lactic acid aroma.

Skeleton analysis of the αs1- and β-caseins was performed to determine the connectivity of the network as described in the Materials and methods. As can be seen from Table 6, the αs1- and β-caseins in the fermented milk produced with EPS producing strain B display a lower network connectivity than that of CEPS producing strain A, whereas the combination of strain A and B results in a network connectivity similar to that of strain A alone. Advantageously, a higher network connectivity results in a stiffer gel, as can be observed from Table 7, summarizing the rheological analysis (G′ and G″ at frequencies of 1 and 10 Hz).

TABLE 1
Pore area distribution

| Pore area in | Comparative | Comparative | |
|---|---|---|---|
| Square | example A | example B | Example 1 |
| micrometer | (% of total | (% of total | (% of total |
| (μm²) | area) | area) | area) |
| <10 | 27.7 | 32.5 | 47.1 |
| 10-100 | 45.9 | 46.3 | 41.1 |
| 100-1000 | 25.7 | 21.2 | 11.8 |

TABLE 2
Protein domain size distribution

| Protein | | | | |
|---|---|---|---|---|
| domain size | | Comparative | Comparative | Example 1, |
| μm | | example A | example B | using both A&B |
| lower | upper | % of total | % of total | % of total |
| bound | bound | count | count | count |
| 0 | 0.5 | 50.00 | 48.15 | 56.67 |
| 0.5 | 1.0 | 42.86 | 33.33 | 26.67 |
| 1.0 | 1.5 | 7.14 | 7.41 | 16.67 |
| 1.5 | 2.0 | 0.00 | 3.70 | 0.00 |

TABLE 3
Void fraction of fermented milks prepared with strains
A, B and AB. Void fractions of the strains are
presented as percentage of the total area.

| | Comparative | Comparative | Example 1, |
|---|---|---|---|
| Void | example A | example B | using both A&B |
| fraction | (%) | (%) | (%) |
| 0.4-0.45 | 2 | 10 | 0 |
| 0.4-0.5 | 12 | 48 | 24 |
| 0.5-0.55 | 74 | 42 | 76 |
| 0.55-0.6 | 12 | 0 | 0 |

TABLE 4
outlines the percentage of syneresis, calculated from
the weights of the free serum and the total sample.

| Example | Total (g) | Serum (g) | Syneresis (%) |
|---|---|---|---|
| Comparative example A | 239.6 | 10.0 | 4.2 |
| Comparative example B | 218.8 | 2.3 | 1.1 |
| Example 1 (combination) | 222.2 | 4.4 | 2.0 |

TABLE 5
Fermentation kinetics of A, B and AB

| | Comparative | Comparative | |
|---|---|---|---|
| | example A | example B | Example 1 |
| TTR pH 4.6 | 8:10 | 5:58 | 8:31 |
| pH 20 h | 4.55 | 4.14 | 4.55 |

TABLE 6
Connectivity of α-s1 and β-casein by means of skeleton analysis.

| | Comparative example A | | Comparative example B | | Example 1 | |
|---|---|---|---|---|---|---|
| | βCN | αs₁CN | βCN | αs₁CN | βCN | αs₁CN |
| Average | 0.47 | 0.54 | 0.32 | 0.48 | 0.52 | 0.61 |

TABLE 7
Results of rheology measurements: Storage modulus (G′,
i.e. the elastic modulus) and loss modulus (G″, i.e. the
viscous modulus) of A, B and AB at frequencies of 1 and 10 Hz.

| Frequency | Comparative example A | | Comparative example B | | Example 1 | |
|---|---|---|---|---|---|---|
| (Hz) | G′ | G″ | G′ | G″ | G′ | G″ |
| 1 | 130.7 | 39.9 | 93.2 | 26.2 | 132.7 | 37.7 |
| 10 | 189.7 | 65.3 | 128.3 | 40.4 | 185.3 | 60.0 |

The results in Table 6 and Table 7, illustrate the positive influence of the casein microstructural connectivity on the rheological characteristics of fermented milk gel. When αs₁- and β-caseins are intertwined together with a similar and high level of connectivity, as is the case for example 1, a stiffer gel is formed than would be expected on the basis of the results of comparative example A and comparative example B, thus illustrating a synergistic effect.

### Example 2

Fermented Milk Products from an Incubation Method

Repeated experiments were carried out as described above, except that in these repeated experiments fermented yoghurt was obtained by using an incubation oven to ferment yoghurt within the slides instead of a microscope heating stage. In addition, the yoghurt was equilibrated for a day in the fridge before being measured. This method of measurement is less preferred, but added for completeness sake.

The results of the pore area determination is provided below in Table 8

TABLE 8

| Pore area | | Comparative | Comparative | Example 1, using |
|---|---|---|---|---|
| μm2 | | example A | example B | both A&B |
| lower | upper | fraction of | fraction of | fraction of |
| bound | bound | total area | total area | total area |
| 0 | 25 | 0.41 | 0.58 | 0.60 |
| 25 | 50 | 0.14 | 0.15 | 0.16 |
| 50 | 75 | 0.08 | 0.06 | 0.07 |
| 75 | 100 | 0.06 | 0.04 | 0.04 |

### Conclusion:

As illustrated above, the use of a starter culture or kit of parts according to the invention can have many advantages. Without wishing to be bound to any kind of theory, it is believed that with the starter culture or kit of parts according to the invention a fermented milk product can be created having an improved structure as illustrated above and/or can lead to a lower syneresis. Without wishing to be bound to any kind of theory, the lower syneresis may be attributed to the high connectivity of the caseins, the large size of the protein domains, and the large proportion of small pores in the yoghurt fermented with a mixture of both strains.

### LITERATURE

Ako, K., Durand, D., Nicolai, T. & Becu, L. Quantitative analysis of confocal laser scanning microscopy images of heat-set globular protein gels. Food Hydrocoll. 23, pp 1111-1119 (2009).
Babella, G. Scientific and practical results with use of ultrafiltration in Hungary. Int. Dairy Fed. 244, pp 7-24 (1989).
Glover, Z. J. et al. Super-resolution microscopy and empirically validated autocorrelation image analysis discriminates microstructures of dairy derived gels. Food Hydrocoll. 90, pp 62-71 (2019).
Pujals, S., Feiner-Gracia, N., Delcanale, P., Voets, I., & Albertazzi, L. (2019). Super-resolution microscopy as a powerful tool to study complex synthetic materials. Nature Reviews Chemistry, 3 (2), pp 68-84.
Robertson, C. Theory and practical recommendations for autocorrelation-based image correlation spectroscopy. J. Biomed. Opt. 17, 080801 (2012).
Suzuki, S. & be, K. A. Topological structural analysis of digitized binary images by border following. Comput. Vision, Graph. Image Process. 30, pp 32-46 (1985).
Lee, T, Building Skeleton Models via 3-D Medial Surface/Axis Thinning Algorithms, Graph. Model. Image Process. 56, pp 462-478 (1994).
Arganda-Carreras I, Fernández-González R., Muñoz-Barrutia A., Ortiz-De-Solorzano C., 3D reconstruction of histological sections: Application to mammary gland tissue, Microsc. Res. Tech. 73 pp 1019-1029 (2010).
Polymer Gel Rheology and Adhesion, Rheology. (2012). https://doi.org/10.5772/36975.

1. A fermented milk product, wherein the fermented milk product comprises:
a porous protein network;
a first, capsular, optionally negatively charged, exopolysaccharide; and
a second, non-capsular, optionally neutral, exopolysaccharide.

2. The fermented milk product of claim 1, wherein the fermented milk product has a structure wherein equal to or more than 35% of the total pore area comprises pores having a pore area of equal to or less than 10 square micrometer.

3. The fermented milk product according to claim 1, wherein the porous protein network is a porous casein network.

4. The fermented milk product according to claim 1, wherein the porous protein network is an interconnected casein network comprising or consisting of beta (β) caseins and/or alpha (α) caseins, optionally αS1-caseins.

5. The fermented milk product according to claim 1, wherein the first exopolysaccharide and/or the second exopolysaccharide is a heteropolysaccharide.

6. The fermented milk product according to claim 1, wherein the second exopolysaccharide comprises a repeating unit, wherein said repeating unit comprises at least an N-acetylgalactosamine monosaccharide.

7. The fermented milk product according to claim 1, wherein the second exopolysaccharide comprises a repeating unit, wherein said repeating unit is a pentasaccharide comprising monosaccharides glucose and galactose and rhamnose and N-acetylgalactosamine.

8. The fermented milk product according to claim 1, wherein the fermented milk product has a protein domain size distribution wherein equal to or more than 10% of the total count lies within a range from equal to or more than 1.0 to equal to or less than 1.5 micrometres.

9. The fermented milk product according to claim 1, wherein the fermented milk product has an average β-casein connectivity of 0.50 at least and/or an α-s1-casein connectivity of at least 0.60.

10. The fermented milk product according to claim 1, wherein the fermented milk product is a yoghurt or a cheese, optionally a set yoghurt, kefir, dahi, ymer, sour cream quark or cottage cheese.

11. A starter culture or kit of parts, comprising a first, capsular, optionally negatively charged, optionally mesophilic, exopolysaccharide producing lactic acid bacterial strain and a second, non-capsular, optionally neutral, optionally thermophilic, exopolysaccharide producing lactic acid bacterial strain, wherein a weight ratio of the weight of the first exopolysaccharide producing lactic acid bacterial strain to the weight of the second exopolysaccharide producing lactic acid bacterial stain in the starter culture lies in a range from equal to or more than 1:1 to equal to or less than 100:1, optionally in a range from equal to or more than 10:1 to equal to or less than 100:1.

12. The starter culture or kit of parts according to claim 11 wherein the first exopolysaccharide producing lactic acid bacterial strain is a Lactococcus lactis biovar diacetylactis strain producing a first, capsular, optionally negatively charged, exopolysaccharide.

13. The starter culture or kit of parts according to claim 11, wherein the second exopolysaccharide producing lactic acid bacterial strain is a Streptococcus thermophilus strain producing a second, non-capsular, optionally neutral, exopolysaccharide.

14. The starter culture or kit of parts according to claim 11, wherein the starter culture further comprises at least a Lactobacillus delbruekii subsp. bulgaricus strain.

15. A product comprising a starter culture or kit of parts according to claim 11, for production of a fermented milk product.

16. A process for production of a fermented milk product comprising fermentation of a milk base in the presence of a first, capsular, optionally negatively charged, exopolysaccharide producing lactic acid bacterial strain and a second, non-capsular, optionally neutral, exopolysaccharide producing lactic acid bacterial strain, wherein the weight ratio of the weight of first exopolysaccharide producing lactic acid bacterial strain to the weight of the second exopolysaccharide producing lactic acid bacterial stain lies in a range from equal to or more than 1:1 to equal to or less than 100:1, optionally in a range from equal to or more than 10:1 to equal to or less than 100:1.

17. The process according to claim 16, wherein the first exopolysaccharide producing lactic acid bacterial strain is a Lactococcus lactis biovar diacetylactis strain producing a first, capsular, optionally negatively charged, exopolysaccharide.

18. The process according to claim 16, wherein the second exopolysaccharide producing lactic acid bacterial strain is a Streptococcus thermophilus strain producing a second, non-capsular, optionally neutral, exopolysaccharide.
